(19) United States
(12) Patent Application Publication
(10) Pub. No.: US 2026/0340074 A1
(43) Pub. Date: Oct. 29, 2026

(54) HARDWARE-AWARE WEIGHT ADAPTATIONS FOR ANALOG IN-MEMORY COMPUTE

(71) Applicant: INTERNATIONAL BUSINESS MACHINES CORPORATION, Armonk, NY (US)

(72) Inventors: Charles Mackin, San Jose, CA (US); Andrea Fasoli, San Jose, CA (US)

(21) Appl. No.: 19/192,903

(22) Filed: Apr. 29, 2025

(51) Int. Cl. G06F 17/16

(52) U.S. Cl. CPC G06F 17/16

(57) ABSTRACT

A method includes characterizing hardware properties of an analog in-memory compute device; and iteratively modifying weights of a pre-trained neural network model stored on the based on the analog in-memory compute device in accordance with the characterized hardware properties. The iterative modification of weights includes adjusting a selected weight in a column of a weight matrix to a new value using a specified update strategy based on the hardware properties and modifying other weights in a same column to compensate for changes in vector-matrix multiplication resulting from the adjustment of the selected weight. The modified weights are programmed into the analog in-memory compute device.

### BACKGROUND

The present invention generally relates to analog in-memory compute (AIMC) systems, and more particularly to AIMC chips with post-training hardware-aware weight adaptation algorithms to iteratively modify neural network weights based on characterized analog memory properties.

Analog in-memory compute (AIMC) addresses the increasing computational demands and energy constraints of modern artificial intelligence and machine learning applications. By performing computations directly within memory arrays, AIMC systems can significantly reduce data movement and potentially achieve orders of magnitude improvements in energy efficiency compared to conventional digital architectures

### SUMMARY

In accordance with an embodiment of the present invention, a method includes characterizing hardware properties of an analog in-memory compute device; and iteratively modifying weights of a pre-trained neural network model stored on the analog in-memory compute device in accordance with the characterized hardware properties. The iterative modification of weights includes adjusting a selected weight in a column of a weight matrix to a new value using a specified update strategy based on the hardware properties and modifying other weights in a same column to compensate for changes in vector-matrix multiplication resulting from the adjustment of the selected weight. The modified weights are programmed into the analog in-memory compute device.

In accordance with another embodiment of the present invention, a system includes a processor set, one or more computer-readable storage media and program instructions stored on the one or more computer-readable storage media to cause the processor set to perform operations. The operations include characterizing hardware properties of an analog in-memory compute device and iteratively modifying weights of a pre-trained neural network model stored on the analog in-memory compute device in accordance with the characterized hardware properties. Iterative modification of weights includes adjusting a selected weight in a column of a weight matrix to a new value using a specified update strategy based on the hardware properties; modifying other weights in a same column to compensate for changes in vector-matrix multiplication resulting from the adjustment of the selected weight and programming the modified weights into the analog in-memory compute device.

In accordance with another embodiment of the present invention, a system includes a hardware characteristics database that stores information about non-idealities and behavior of an analog chip. The system also includes a weight adjustment algorithm that is configured to iteratively modify the weights of a neural network on the analog chip to compensate for hardware non-idealities present in the analog chip.

In accordance with another embodiment of the present invention, a computer program product includes one or more computer-readable storage media and program instructions stored on the one or more computer-readable storage media to perform operations. The operations include characterizing hardware properties of an analog in-memory compute device and iteratively modifying weights of a pre-trained neural network model stored on the analog in-memory compute device in accordance with the characterized hardware properties. The iterative modification of weights includes adjusting a selected weight in a column of a weight matrix to a new value using a specified update strategy based on the hardware properties; modifying other weights in a same column to compensate for changes in vector-matrix multiplication resulting from the adjustment of the selected weight; and programming the modified weights into the analog in-memory compute device.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures, wherein:

FIG. 1 is a block/flow diagram showing a system for adapting weights of a neural network on an analog chip or device, in accordance with an embodiment of the present invention;

FIG. 2 is a block/flow diagram showing a method for adapting weights of the neural network on the analog device, in accordance with an embodiment of the present invention;

FIG. 3 is a diagram showing an example of a preference distribution versus weight comparing a digital distribution and an analog distribution, in accordance with an embodiment of the present invention;

FIG. 4 is a diagram showing a standard deviation in error versus weight function, in accordance with an embodiment of the present invention;

FIG. 5 are plots showing characteristics (non-idealities) of an analog device used for adapting weights and including standard deviations in programming error versus conductance, drift coefficient versus conductance and read noise versus conductance, in accordance with an embodiment of the present invention;

FIG. 6 is a diagram showing a neural network realized on an analog device and showing a vector-matrix multiplication computed by the analog device, in accordance with an embodiment of the present invention;

FIG. 7 is a block diagram showing a computer environment for hardware-aware weight adaptations for analog in-memory compute, in accordance with an embodiment of the present invention; and

FIG. 8 is a flow diagram showing methods for hardware-aware weight adaptations for analog in-memory compute, in accordance with an embodiment of the present invention.

### DETAILED DESCRIPTION

In accordance with embodiments of the present invention, post-training hardware-aware weight adaptation systems and methods are provided for analog in-memory compute (AIMC) systems. The embodiments address the challenges posed by hardware variability in AIMC implementations, such as programming errors, read noise, weight density and conductance drift, etc. without requiring extensive hardware-aware training. By iteratively modifying neural network weights based on analog memory properties, the embodiments improve device operations, e.g., multiply-accumulate (MAC) fidelity and inference accuracy of AIMC systems while reducing the need for computationally expensive hardware-aware training processes.

In accordance with embodiments, an analog memory system can analyze and model non-ideal behavior of the AIMC hardware. A weight adaptation feature iteratively modifies pre-trained floating-point weights based on hardware properties. A compensation feature adjusts the weights within each column to maintain overall vector-matrix multiplication accuracy. A programming interface can translate adapted weights into appropriate conductance values for the analog memory elements. Performance can be evaluated by comparing, e.g., the MAC fidelity and inference accuracy of the adapted network against the original floating-point model.

In accordance with other embodiments, methods include quantifying programming characteristics, such as errors, read noise, weight density, conductance drift, etc. for analog memory elements. A pre-trained floating-point neural network model has its weights iteratively adapted such that the weights of each layer are based on the characterized hardware properties and a specified update strategy. For each modified weight in a column, other weights in the same column are compensated to distribute the modification to maintain overall vector-matrix multiplication accuracy. The adapted weights are programmed into the AIMC hardware. The MAC fidelity and inference accuracy of the implemented network can be compared to the original floating-point model to evaluate the weight modification. Portions of the method can be repeated to further optimize performance.

In accordance with an embodiment of the present invention, a method includes characterizing hardware properties of an analog in-memory compute device; and iteratively modifying weights of a pre-trained neural network model stored on the analog in-memory compute device in accordance with the characterized hardware properties. The iterative modification of weights includes adjusting a selected weight in a column of a weight matrix to a new value using a specified update strategy based on the hardware properties and modifying other weights in a same column to compensate for changes in vector-matrix multiplication resulting from the adjustment of the selected weight. The modified weights are programmed into the analog in-memory compute device. The modified weights account for non-idealities of the neural network to improve and optimize performance.

In other embodiments, characterizing the hardware properties can include quantifying at least one of: programming errors, read noise, conductance drift, and precision limitations of analog memory elements in the analog in-memory compute device. The specified update strategy can be based on an error function that correlates error and weight values for the analog in-memory compute device. Iteratively modifying the weights can further include determining error information for each weight and prioritizing weight adjustments for weights with larger error information. Iteratively modifying weights can be performed until a loss metric is achieved. Adjusting the selected weight can include constraining the adjustment to a range determined based on characterized hardware properties to prevent excess distortion. Modifying other weights can include adapting weights in accordance with one or more of weight density, a weight error metric and a weight error metric gradient. Programming the modified weights can include translating weight values into conductance values for analog memory elements in the analog in-memory compute device.

In accordance with the present embodiments, the methods described employ analog neural network models provided with post-training adaptation techniques. In particular, AIMC can be employed to address the increasing computational demands and energy constraints of modern artificial intelligence and machine learning applications. By performing computations directly within memory arrays, AIMC systems can significantly reduce data movement and potentially achieve orders of magnitude improvements in energy efficiency compared to conventional digital architectures.

The challenges that AIMC systems face are mitigated in accordance with the present embodiments by addressing primary issues in analog memory devices, such as phase-change memory (PCM), resistive random-access memory (RRAM), magneto resistive random-access memory (MRAM), electrochemical random-access memory (ECRAM) and flash memory. These issues include programming errors, noise fluctuations, conductance drift, reduced bit resolution, weight density, among others. The embodiments of the present invention address these issues by introducing a post-training hardware-aware weight adaptation algorithm for AIMC systems. This approach bridges the gap between floating-point trained networks and their implementation on analog hardware, to bypass or significantly reduce the need for expensive hardware-aware training while maintaining high inference accuracy.

In accordance with another embodiment of the present invention, a system includes a processor set, one or more computer-readable storage media and program instructions stored on the one or more computer-readable storage media to cause the processor set to perform operations. The operations include characterizing hardware properties of an analog in-memory compute device and iteratively modifying weights of a pre-trained neural network model stored on the analog in-memory compute device in accordance with the characterized hardware properties. Iterative modification of weights includes adjusting a selected weight in a column of a weight matrix to a new value using a specified update strategy based on the hardware properties; modifying other weights in a same column to compensate for changes in vector-matrix multiplication resulting from the adjustment of the selected weight and programming the modified weights into the analog in-memory compute device. The modified weights account for non-idealities of the neural network to improve and optimize performance.

In other embodiments, characterizing the hardware properties can include quantifying at least one of: programming errors, read noise, conductance drift, and precision limitations of analog memory elements in the analog in-memory compute device. The specified update strategy can be based on an error function that correlates error and weight values for the analog in-memory compute device. Iteratively modifying the weights can further include determining error information for each weight and prioritizing weight adjustments for weights with larger error information. Iteratively modifying weights can be performed until a loss metric is achieved. Adjusting the selected weight can include constraining the adjustment to a range determined based on characterized hardware properties to prevent excess distortion. Modifying other weights can include adapting weights in accordance with one or more of weight density, a weight error metric and a weight error metric gradient. Programming the modified weights can include translating weight values into conductance values for analog memory elements in the analog in-memory compute device.

The challenges that AIMC systems face are mitigated in accordance with the present embodiments by addressing primary issues in analog memory devices. These issues include programming errors, noise fluctuations, conductance drift, reduced bit resolution, weight density, among others. The embodiments of the present invention address these issues by introducing a post-training hardware-aware weight adaptation algorithm for AIMC systems. This approach bridges the gap between floating-point trained networks and their implementation on analog hardware, to bypass or significantly reduce the need for expensive hardware-aware training while maintaining high inference accuracy.

In accordance with another embodiment of the present invention, a system includes a hardware characteristics database that stores information about non-idealities and behavior of an analog chip. A weight adjustment algorithm is configured to iteratively modify the weights of a neural network of the analog chip to compensate for hardware non-idealities present in the analog chip.

In other embodiments, a testing and simulation platform configured to discover and quantify hardware characteristics of the analog chip can be included. The analog chip can perform vector-matrix multiplications. The analog chip can include at least one of PCM, RRAM, MRAM, ECRAM and flash memory. The hardware characteristics database can store information including weight density, programming error models, read noise profiles, conductance drift models, and precision limitations of memory elements on the analog chip. The weight adjustment algorithm can utilize information from the hardware characteristics database to make informed decisions on weight adaptations. The weight adjustment algorithm can iteratively refine the weights to compensate for hardware non-idealities to achieve multiply-accumulate (MAC) fidelity and inference accuracy at least comparable to an original floating-point model when executed on the analog chip.

In accordance with another embodiment of the present invention, a computer program product includes one or more computer-readable storage media and program instructions stored on the one or more computer-readable storage media to perform operations. The operations include characterizing hardware properties of an analog in-memory compute device and iteratively modifying weights of a pre-trained neural network model stored on the analog in-memory compute device in accordance with the characterized hardware properties. The iterative modification of weights includes adjusting a selected weight in a column of a weight matrix to a new value using a specified update strategy based on the hardware properties; modifying other weights in a same column to compensate for changes in vector-matrix multiplication resulting from the adjustment of the selected weight; and programming the modified weights into the analog in-memory compute device. This bypasses or significantly reduces the need for expensive hardware-aware training while maintaining high inference accuracy. The modified weights account for non-idealities of the neural network to improve and optimize performance.

In other embodiments, characterizing the hardware properties can include quantifying at least one of: programming errors, read noise, conductance drift, and precision limitations of analog memory elements in the analog in-memory compute device. The specified update strategy can be based on an error function that correlates error and weight values for the analog in-memory compute device. Iteratively modifying the weights can further include determining error information for each weight and prioritizing weight adjustments for weights with larger error information. Iteratively modifying weights can be performed until a loss metric is achieved. Adjusting the selected weight can include constraining the adjustment to a range determined based on characterized hardware properties to prevent excess distortion. Modifying other weights can include adapting weights in accordance with one or more of weight density, a weight error metric and a weight error metric gradient. Programming the modified weights can include translating weight values into conductance values for analog memory elements in the analog in-memory compute device.

In this way, AIMC system challenges are mitigated in accordance with the present embodiments by addressing hardware issues, e.g., programming errors, noise fluctuations, conductance drift, reduced bit resolution, weight density, among others. The embodiments of the present invention address these issues by introducing a post-training hardware-aware weight adaptation algorithm for AIMC systems. This approach bridges the gap between floating-point trained networks and their implementation on analog hardware, to bypass or significantly reduce the need for expensive hardware-aware training while maintaining high inference accuracy.

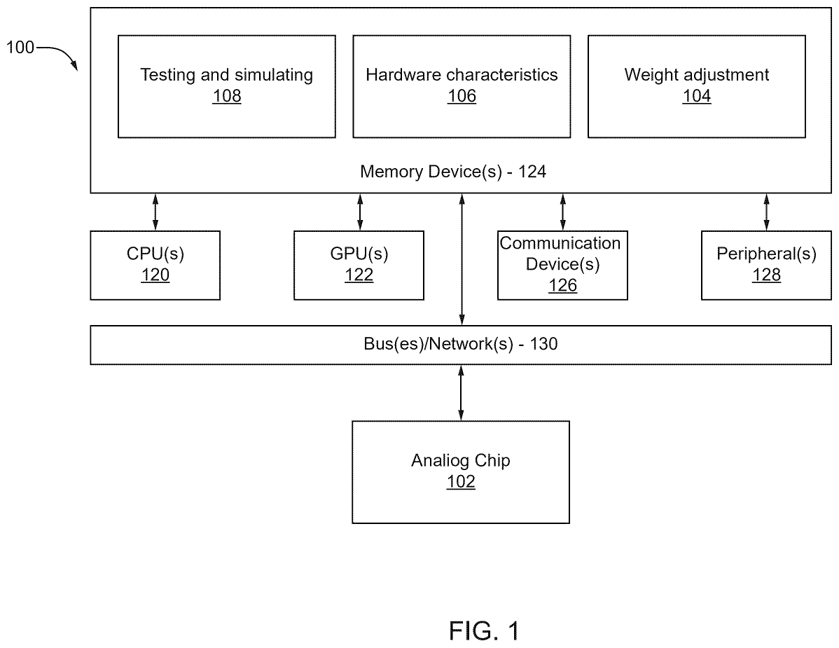

Referring now to the drawings in which like-numerals represent the same or similar elements and initially to FIG. 1, a system 100 for post-training hardware-aware weight adaptation in analog in-memory compute (AIMC) systems is described and shown. The system 100 includes a set of processing units (e.g., CPUs) 120, a set of GPUs 122, a set of memory devices 124, a set of communication devices 126, and set of peripherals 128. The CPUs 120 can be single or multi-core CPUs. The GPUs 122 can be single or multi-core GPUs. The one or more memory devices 124 can include caches, random-access memories (RAMs), read-only memories (ROMs) and other memories (flash, optical, magnetic, etc.). The communication devices 126 can include wireless and/or wired communication devices (e.g., network (e.g., WIFI, etc.) adapters, etc.). The peripherals 128 can include a display device, a user input device, a printer, an imaging device, and so forth. Elements of system 100 are connected by one or more buses or networks (collectively denoted by the figure reference numeral 130).

In an embodiment, memory devices 124 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 124 store program code for implementing post-training hardware-aware weight adaptation in AIMC systems. The AIMC systems can be embodied in a semiconductor chip, e.g., an analog chip 102. The analog chip 102 can store a neural network having weights which can be reprogrammed to optimize performance.

Of course, the system 100 may also include other elements (not shown), as readily contemplated by one of skill in the art, as well as omit certain elements. For example, various other input devices and/or output devices can be included in the system 100, depending upon the particular implementation. For example, various types of wireless and/or wired input and/or output devices can be used. Moreover, additional processors, controllers, memories, and so forth, in various configurations can also be utilized. These and other variations of the system 100 are readily contemplated by one of ordinary skill in the art given the teachings of the present invention provided herein.

Moreover, it is to be appreciated that various figures as described below with respect to various elements and steps relating to the present invention that may be implemented, in whole or in part, by one or more of the elements of the system 100. The system 100 can be embodied as a single chip, a computer or a combination of software, memory and a hardware processor. Program code run on one or more processing systems can be employed to adapt the weights of a neural network and reprogram the weights (e.g., conductances).

The system 100 can employ stored testing information to adapt a neural network stored on the analog chip 102. The analog chip 102 can include an in-memory compute device, which serves as the target hardware for implementing a neural network. The analog chip 102 can incorporate analog memory elements, such as, e.g., at least one of phase-change memory (PCM), resistive random-access memory (RRAM), magneto resistive random-access memory (MRAM), electrochemical random-access memory (ECRAM), flash memory, etc., arranged in arrays to perform vector-matrix multiplications (or other operations) directly in memory.

A weight adjustment algorithm 104 is programmed to iteratively modify pre-trained floating-point weights of a neural network stored on the analog chip 102 to compensate for the hardware non-idealities present in the analog chip 102. The weight adjustment algorithm 104 utilizes information from the hardware characteristics database 106 to make informed decisions on weight adaptations.

A hardware characteristics database 106 stores detailed information about the non-idealities and behavior of the analog chip 102. The hardware characteristics database 106 can include, e.g., programming error models that describe the discrepancies between intended and actual conductance values for programming weights, read noise profiles that characterize the fluctuations in read currents during computation, conductance drift models that capture the time-dependent changes in programmed conductance values, precision limitations of analog memory elements of the analog chip 102, etc. Other characteristics can also be stored and employed by the hardware characteristics database 106. In addition, any combination of these and other characteristics can be stored and employed to compute weight adjustments in accordance with the weight adjustment algorithm 104.

A testing and simulation platform 108 can be employed to discover and quantify the hardware characteristics of the analog chip 102. This platform performs various measurements and analyses, which can include, e.g., conductance programming tests to measure programming errors across the range of possible weight values; read noise measurements to characterize the statistical distribution of noise during read operations; long-term stability tests to model conductance drift over time; precision analysis to determine the effective resolution of the analog memory elements, weight density, etc.

The system 100 can use the testing and simulation platform 108 to thoroughly characterize the analog chip 102. The resulting data is stored in the hardware characteristics database 106. The weight adjustment algorithm 104 then uses this information to adapt the weights of a pre-trained neural network, optimizing them for implementation on the analog chip 102. This process iteratively refines the weights to compensate for hardware non-idealities, aiming to achieve MAC fidelity and inference accuracy at least comparable to the original floating-point model when executed on the analog hardware.

One of the primary issues AIMC systems is the inherent variability in analog memory devices, such as PCM or RRAM. The variability can include programming errors from imprecise settings of conductance values during weight programming. Other issues include read noise fluctuations in the read current during computation and conductance drift (e.g., time-dependent changes in the programmed conductance values). There can also be limited precision due to reduced bit resolution compared to floating-point (FP) digital representations. These hardware imperfections can lead to significant degradation in the accuracy of neural network inference when implemented on AIMC systems.

In accordance with embodiments of the present invention, analog in-memory compute hardware non-idealities are mitigated to rival and exceed performance of digital FP trained networks. The embodiments avoid hardware-aware (HWA) pre-training, which requires modifying PyTorch™/TensorFlow™ backends to incorporate many hardware imperfections. Such training is tedious and time consuming as well as computationally expensive. Further, HWA pre-training can also be difficult to converge on floating-point accuracy despite best efforts. The present embodiments can bypass the expensive HWA-training process or at least provide a head start for HWA-training process by making favorable adjustments to the model weights.

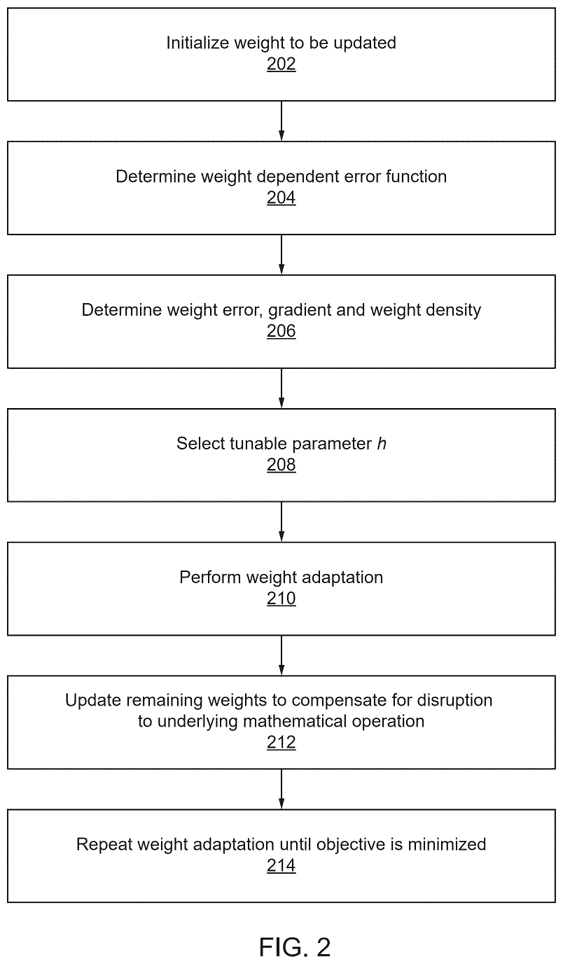

Referring to FIG. 2 with continued reference to FIG. 1, the weight adjustment algorithm 104 is shown in greater detail for programming weights for analog in-memory compute in accordance with an embodiment. In block 202, the weight adjustment algorithm 104 initializes a given weight w to be updated. In an example, the weight w=g⁺−g⁻, where g⁺ is a positive conductance component and g⁻ represents the negative conductance component. Positive and negative conductance values in an analog memory device, such as a memristor or phase-change memory cell, are employed to encode synaptic weights. The weight w is then determined by the difference between these two conductance values. This approach permits the representation of both positive and negative weights (differential pair) using only positive conductance values, which is often needed in physical implementations of analog memory devices. This differential encoding helps mitigate some hardware non-idealities and permits more precise weight representation in analog computing systems.

In block 204, a weight dependent error function is determined to correlate error and weight. In an example, an error function can be determined or selected as an error in standard deviation (o) of weight as an infinite series or a fitted polynomial curve. For example, the algorithm can model error introduced by analog hardware using a polynomial fit:

Error: E_{σ}≈polyfit(σ(w))=a₀+a₁w+a₂w²+ . . . ,

where E_{σ} is the error in standard deviation and a; are coefficients of the series. The error function can be derived by fitting data stored relative to a particular target hardware device.

In block 206, weight error, gradient and weight density for the weights in a neural network are determined. For example, an error change rate or gradient can be determined mathematically. In the example,

$$\frac{{dE}_{σ}}{dw} \approx {a}_{1} + 2 {a}_{2} w + 3 {a}_{2} {w}^{2} + … ,$$

can be obtained as the derivative of E_{σ} with respect to the weights w.

In block 208, a tunable parameter h is selected. The tunable parameter h is hardware dependent. The value of h determines convergence rate for weight adaptation computations. The value of h can be selected to bias weight adaptations to regions of a characterization parameter versus conductance curve that has the most impact or has shown the historical best results. In an embodiment, the characterization parameter can include, e.g., programming error, drift coefficient, read noise or any other parameter that characterizes the hardware configuration as a function of conductance or other physical parameter that quantifies weight values.

In block 210, weight adaptation is performed. In an embodiment, an adapted weight (wₐ) can be computed using an adapted weight function, adapt (wₐ). For example, adapt (Wₐ) can be expressed as:

$$adapt ( {w}_{a} ) = {w}_{a} - h \cdot \frac{{dE}_{σ}}{dw} {\vert}_{{w}_{a}}$$

where the weights are constrained by:

$$w = \{ \begin{matrix}{g}^{+} - {g}_{m i n} & w > 0 \\ {g}_{m i n} - {g}_{m i n} & w = 0 \\ {g}_{m i n} - {g}^{-} & w < 0\end{matrix} .$$

The algorithm iteratively adapts the weights using a small step size h. The algorithm limits the range of weight adaptations to prevent excessive distortion. Distortion is excessive if it prevents the algorithm from being properly compensated to perform the underlying mathematical operation.

In the context of analog in-memory compute systems, gₘᵢₙ and gₘₐₓ refer to the minimum and maximum conductance values that can be reliably programmed and read from the analog memory devices. The gₘᵢₙ and gₘₐₓ parameters provide a range and resolution of weight values that can be represented in the hardware. gₘᵢₙ represents the minimum conductance value that can be reliably set in the analog memory device and corresponds to the lowest positive weight value that can be represented. gₘₐₓ represents the maximum conductance value that can be reliably set in the analog memory device and corresponds to the highest positive weight value that can be represented.

The range between gₘᵢₙ and gₘₐₓ defines the dynamic range of the analog memory elements. This range is employed to determine the precision with which weights can be represented and a number of distinct weight levels that can be programmed. Both g⁺ and g⁻ are constrained to fall within the range [gₘᵢₙ, gₘₐₓ]. This constraint affects how weights are mapped to the physical conductance values and influences the weight adaptation process.

In other embodiments, different weight adaptation strategies can be employed. For example, in an embodiment:

$${w}_{i + 1} = adapt ( {w}_{i} ) = {w}_{i} - h \cdot \frac{{dE}_{σ}}{dw} {\vert}_{{w}_{i}} {E}_{σ} ( {w}_{i + 1} ) = {E}_{σ} ( {w}_{i} ) - h \cdot \frac{{dE}_{σ}}{dw} {\vert}_{{w}_{i}} .$$

In another embodiment:
maximize:

$${E}_{σ} ( {w}_{i} ) - {E}_{σ} ( {w}_{i + 1} ) = h \cdot \frac{{dE}_{σ}}{dw} {\vert}_{{w}_{i}}$$

This can get the largest reduction in E_{σ} by adjusting weights with the largest

$$\frac{{dE}_{σ}}{dw} .$$

This does not perturb MAC where

$$\frac{{dE}_{σ}}{dw} \approx 0$$

since there is little or no effect.

In another embodiment: adapt (wₐ)=wₐ−h·sign(dE_{σ}/dw) can be employed. This strategy can move weights by h even if the derivative is approaching zero.

In another embodiment: adapt (wₐ)=wₐ−h·(dE_{σ}/dw)⁻¹ will perturb weights with near-zero derivative the most. Other adaptation strategies are also contemplated.

In block 212, the remaining weights are updated. This includes adjusting the weights to compensate for disruption to the underlying mathematical operation being performed. For example, if the operation is vector multiplication, the other weights need to be adjusted to compensate for earlier weight changes to obtain an accurate result. In addition, the weight adaptation process in block 210 is dependent on a preference or probability distribution of the weights, denoted as p (w). The preference or probability distribution p (w) (weight density) represents the distribution of the weights in the neural network and describes how the weight values are spread across their possible range. The weight adaptation process is not only based on the error gradient

$$( \frac{{dE}_{σ}}{dw} )$$

but also takes into account the underlying physical distribution of the weights. The shape of p (w) can influence how aggressively or conservatively weights are adapted. For example, if p (w) shows a high density of weights near zero, the adaptation may be more conservative for small weights to preserve this distribution. If p (w) has a wide spread, the adaptation can allow for more significant changes to weights across the entire range.

In block 214, the weight adaptations are repeated until an objective function is minimized, e.g.,

$$arg {min}_{\hat{W}} = {‖ WX - \hat{W} X ‖}_{2}^{2}$$

(e.g., stop when the function increases). This objective function takes a difference between the output of the original weights (W) and the adapted weights (Ŵ) when applied to input X. Other objective functions can also be employed.

In some embodiments, a Generative Pre-trained Transformer Quantization (GPTQ) algorithm is employed as a weight update strategy to propagate weight updates across a network. This provides layer-wise post-training quantization to solve a corresponding reconstruction problem for each layer. In such an algorithm, let Wₗ be the weights corresponding to a linear layer l, and let Xₗ denote the layer input corresponding to a small set of m data points running through the network. Then, the objective is to find a matrix of quantized weights Ŵ which minimizes the squared error, relative to the full precision layer output. Formally, this can be restated as:

$$arg {min}_{\hat{W}} = {‖ WX - \overline{W} X ‖}_{2}^{2}$$

whose Hessian is H_{F}=2X_{F}X_{F}^{T}, where F denotes the set of remaining full-precision weights, the greedy-optimal weight to quantize next, w_{q}, and the corresponding optimal update of all weights in F, denoted by δ_{F}, are given by the following formulas, where quant (w) rounds w to the nearest value on the quantization grid.

$${w}_{q} = arg {min}_{{w}_{q}} = \frac{{( quant ( {w}_{q} ) - {w}_{q} )}^{2}}{{[ {H}_{F}^{- 1} ]}_{qq}} , \\ {δ}_{F} = arg {min}_{{w}_{w}} = - \frac{{w}_{q} - quant ( {w}_{q} )}{{[ {H}_{F}^{- 1} ]}_{qq}} \cdot {( {H}_{F}^{- 1} )}_{: , q} .$$

Weights are quantized iteratively using w_{g} and δ_{F}, until all the weights of w are quantized. This is done efficiently and avoids full recomputations of the inverse Hessian (H⁻¹), by removing the qth row and column of H, after quantizing w_{q}, directly in the inverse via one step of Gaussian elimination.

The inverse Hessian can be given by:

$${H}_{- q}^{- 1} = {( \frac{{H}^{- 1} - 1}{{[ {H}^{- 1} ]}_{qq} {H}_{: , q}^{- 1} {H}_{q , :}^{- 1}} )}_{- p} .$$

When applied in the digital domain, this method includes a vectorized implementation, handling multiple rows of W in parallel. The final rounding decisions for column i are only affected by updates performed on this the i column and so updates to later columns are irrelevant. This limiting of the rounding to column-specific updates makes it possible to batch updates together for better processor utilization. Once a block or batch has been fully processed, global updates of the entire H⁻¹ and W matrices can be performed using the multi-weight versions of δ_{F} and

$${H}_{- q}^{- 1}$$

with Q denoting a set of indices, and

$${H}_{- Q}^{- 1}$$

denoting the inverse matrix with the corresponding rows and columns removed:

$${δ}_{F} = - \frac{{w}_{Q} - quant ( {w}_{Q} )}{{[ {H}_{F}^{- 1} ]}_{QQ}} \cdot {( {H}_{F}^{- 1} )}_{: , Q} , \\ {H}_{- Q}^{- 1} = {( \frac{{H}^{- 1} - 1}{{[ {H}^{- 1} ]}_{QQ} {H}_{: , Q}^{- 1} {H}_{Q , :}^{- 1}} )}_{- Q} .$$

This update strategy addresses memory-throughput bottlenecks and provides an order of magnitude speedup for very large models in practice, making it a useful component of the algorithm.

The weight adaptation process should effectively reshape the weight distribution (density). In AIMC systems, the physical implementation of weights (as conductance values) imposes constraints or preferences on the weight distribution which are hardware-specific.

The p(w) dependency means that the weight adaptation process is not solely driven by error minimization but also considers the statistical properties and hardware-imposed constraints on the weight distribution.

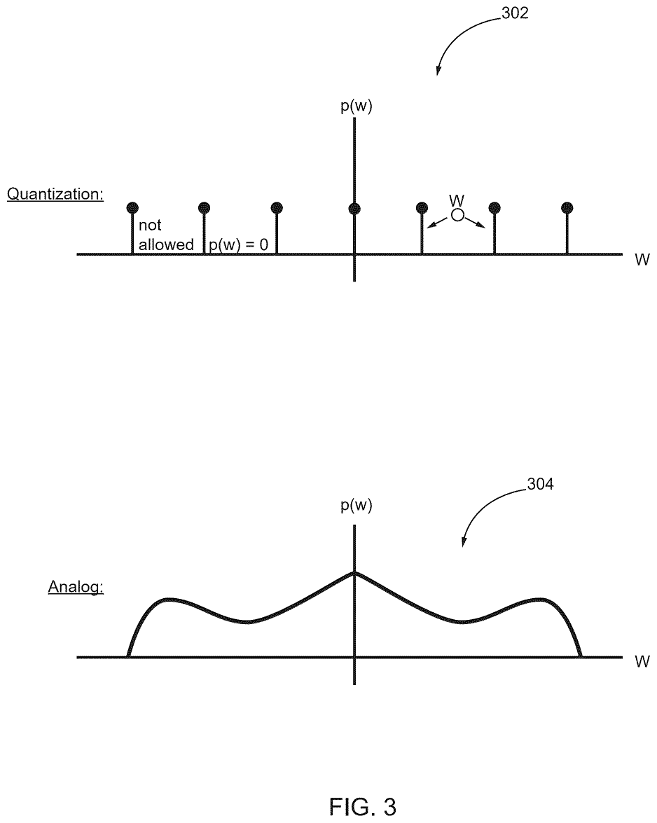

Referring to FIG. 3, an illustration of quantized weight distribution for digital systems versus analog weight distribution is provided. A quantized preference distribution 302 (p(w)) for quantized weights is shown having discrete weights at each position. Regions between these positions do not have a weight distribution (p(w)=0) at non-discrete weight values. Contrast this with an analog preference distribution 304 where p(w) is shown having a more continuous distribution of weights at each position. This feature can assist in weight adaptation since relationships between neighboring positions have a greater influence over a given position. As such, the analog p(w) can have a greater influence on changes to weights that can enhance performance and accuracy. Preference or probability distribution (e.g., weight density) can be employed during adaptation to obtain favorable performance of the neural network/device.

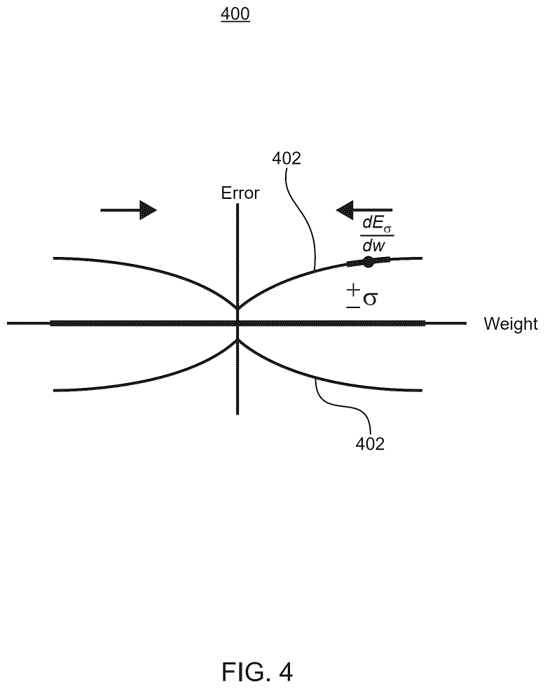

Referring to FIG. 4, a diagram 400 depicts error values versus weight values for a memory device. The diagram 400 shows a relationship of error E_{σ} on the y-axis as a function of weight values (w) on the x-axis. A curve 402 for positive and negative standard deviation (±σ) tends to have a higher slope as they approach zero. Here, the slope is the error gradient

$$( \frac{{dE}_{σ}}{dw} ) .$$

Different E_{σ} will result in potential weight distribution distortions. These distortions can be used to influence the weight adaptations. The weight adaptations can be limited to a range of weight adaptations, e.g.,

$$clip ( \frac{{dE}_{σ}}{dw} h , min = - Δ {w}_{m ax} , max = Δ {w}_{m ax} )$$

can be employed to prevent excessive distortion to optimize the benefit of potential weight distribution compression versus amplification of error (e.g., noise amplification).

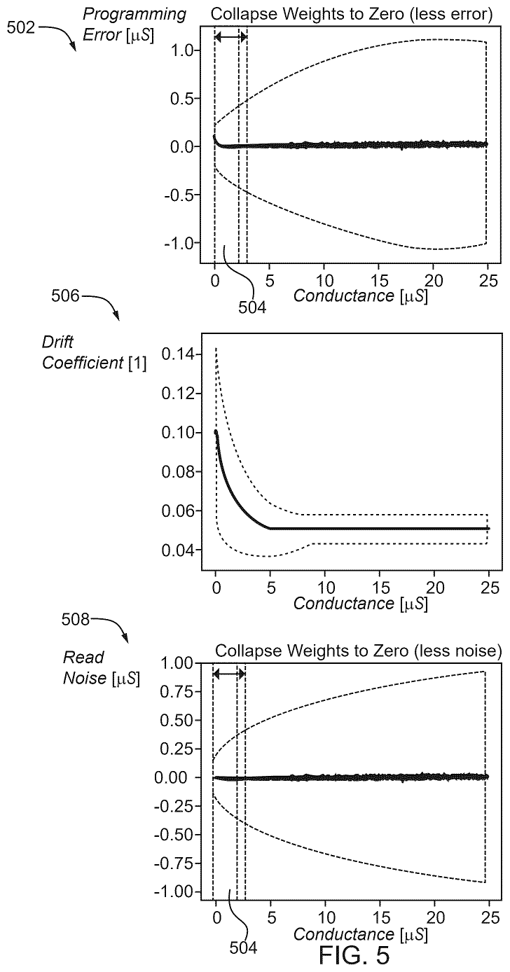

Referring to FIG. 5, diagrams (similar to FIG. 4) of characteristic parameters versus physical matrix values are shown for several performance issues. The characteristic parameters are plotted against conductance values, but in other embodiments other physical properties can also be employed in addition to or instead of the conductance values. The characteristic parameters versus conductance values diagrams can be obtained through physical or virtual testing. The testing is performed on a memory device or other device to characterize the device. These characterizations are employed in providing hardware-aware updating of the weight matrix. The tests can run a simple weight update strategy to generate response data.

A first diagram 502 plots programming error (μS) versus conductance (μS) for a particular device (e.g., an analog accelerator chip). In this example, the simple weight update strategy selects a variable width window 504 of weights near origin and “collapses” the weights to zero. This collapsing means that weights assigned within the window are all set to zero as the simple weight update strategy. There is less error in the weight adaptation near the origin. The highest density of weights is located near the origin, which also represented the steepest slope and the highest reduction in error as well. In this way, the benefit of weight distribution compression is balanced against increased error.

A second diagram 506 plots drift coefficient versus conductance (u S) for the device. A variable width window is not shown but can be provided to “collapse” weights to zero for a particular region. Weights (conductances) near zero can exhibit high drift and high variability in drift. It is likely that by collapsing some of these high drift and high variability drift coefficients to zero will also yield some benefit in the accuracy of the MAC distribution over time.

A third diagram 508 plots read noise error (μS) versus conductance (μS) for the device. A variable width window 504 of weights near origin is “collapsed” to zero. This collapsing means that weights assigned within the window are all set to zero as a simple weight update strategy. There is less noise in the weight adaptation near the origin. The highest density of weights is near the origin as well as the steepest slope or highest reduction in error. In this way, the benefit of weight distribution compression is balanced against amplification of noise.

Using the data provided in the first diagram 502, the second diagram 506 and the third diagram 508, particular weights (e.g., conductances) of a neural network of the device can be updated to permit weight adaptations to reduce training without impact on the performance of the device (e.g., MAC fidelity). The weight adaptation relies on information (error information) obtained by the hardware (device) post-training. A GPTQ algorithm is employed in some embodiments to iteratively update the other weights of the neural network. This results in a post-training hardware-aware weight adaptation method for AIMC systems and optimizes pre-trained neural network weights for implementation on analog hardware while accounting for hardware non-idealities.

The information in the first diagram 502, the second diagram 506 and the third diagram 508 can be used to define an error metric,

$$\frac{{dE}_{σ}}{dw} ,$$

or otherwise can be used to guide the weight adaption algorithm. For example, a weighted sum may be employed to combine multiple error types (e.g., programming error and read noise characteristics) into a single error metric. Additionally, the drift coefficient distribution can introduce some time dependence in weight (conductance) errors. In this case, this error distribution can be used into a weighted sum, which will allow for some optimization of network performance over time.

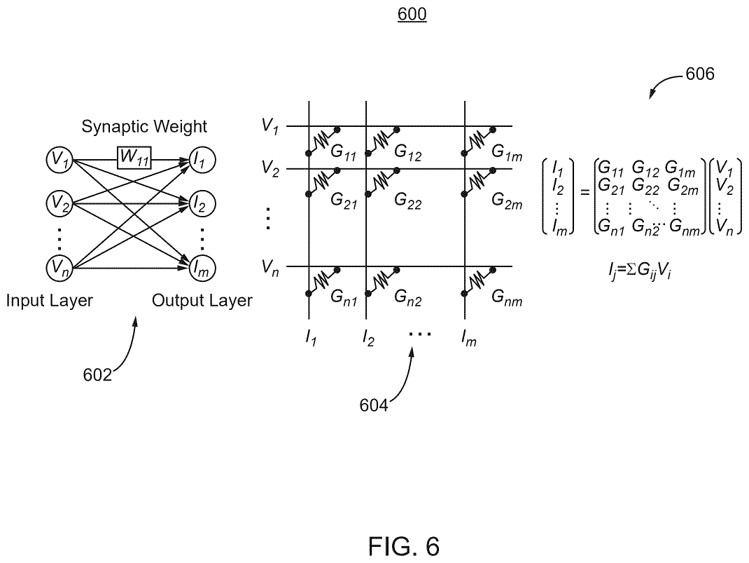

Referring to FIG. 6, a schematic diagram shows a neural network 602 embodied in hardware in the form of a resistive processing unit (RPU) 604 of an analog in-memory compute device 600. The RPU 604 represents an in-memory computation represented mathematically by a vector-matrix multiplication 606. The neural network 602 includes synaptic weights W, e.g., W₁₁. The synaptic weights W are represented as conductances G in the RPU 604, which can have their values adjusted in hardware by having adapted weights reprogrammed in the analog in-memory compute device 600. After analog in-memory compute device 600 is characterized using a trained floating-point network, the weights are adapted based on the memory characteristics and a compensation algorithm. These adapted weights are then programmed into the hardware.

In an embodiment, the reprogramming includes modifying one weight W₁₁ in a column to a more desirable value using a specified weight update strategy. Other weights in a same column are subsequently modified to compensate for the change in the vector-matrix multiplication 606. The modification process is repeated until an entire column has been modified according to the specified weight update strategy. The weight includes a hardware parameter, e.g., one or more conductances G. Other physical properties (e.g., resistance, etc.) can also be employed as weight parameters. The conductances G₁₁-Gₙₘ are accordingly updated with the specified weight update strategy. The conductances are adjusted in accordance with the compensation algorithm. Improved MAC fidelity for the results for the analog in-memory compute device 600 are achieved by updating the weights in accordance with the memory characteristics.

In some embodiments, the neural network 602 is implemented on the analog in-memory compute device 600 to provide an analog in-memory compute (AIMC) system. The analog in-memory compute device 600 can incorporate an array of analog memory elements, such as resistive random-access memory (RRAM), phase-change memory (PCM) cells, etc. to represent the synaptic weights (W) of the neural network. The neural network architecture on the analog in-memory compute device 600 can include multiple layers, including input layers, hidden layers, and output layers. Each layer may be represented by a set of neurons, which in the analog domain can be implemented as voltage (V) or current signals (I). The connections between neurons, represented by synaptic weights, may be realized through the conductance values of the analog memory elements.

In some cases, the input layer of the neural network 602 may receive analog signals directly, which can be voltage or current inputs corresponding to the features of the input data. These input signals may then propagate through the network, with each neuron performing a weighted sum of its inputs using the analog memory elements as multipliers. The resulting sum may be passed through an activation function, which in the analog domain can be implemented using various circuit techniques such as differential pairs or operational transconductance amplifiers.

The hidden layers of the neural network 602 may process the signals in a similar manner, with each neuron receiving inputs from the previous layer, performing a weighted sum using the analog memory elements, and applying an activation function. This process may continue through multiple hidden layers, allowing the network to learn complex representations of the input data.

The output layer may produce analog signals representing the network's predictions or classifications. These analog outputs may be converted to digital form if required by subsequent processing stages or for interfacing with digital systems.

In some implementations, the analog in-memory compute device 600 may incorporate additional circuitry to support the neural network operations. This may include analog-to-digital converters (ADCs) and digital-to-analog converters (DACs) for interfacing with digital systems, as well as peripheral circuits for programming and reading the analog memory elements.

The weight adaptation process described earlier may be applied to this analog neural network implementation. The conductance values of the analog memory elements may be adjusted based on the characterized hardware properties and the specified update strategy. This may allow the network to maintain high accuracy while accounting for the non-idealities of the analog hardware.

In some aspects, a chip having the analog in-memory compute device 600 may also include circuitry for on-chip learning or fine-tuning of the neural network weights. This may involve implementing gradient descent or other optimization algorithms directly in the analog domain, to provide advantages in terms of speed and energy efficiency compared to digital implementations.

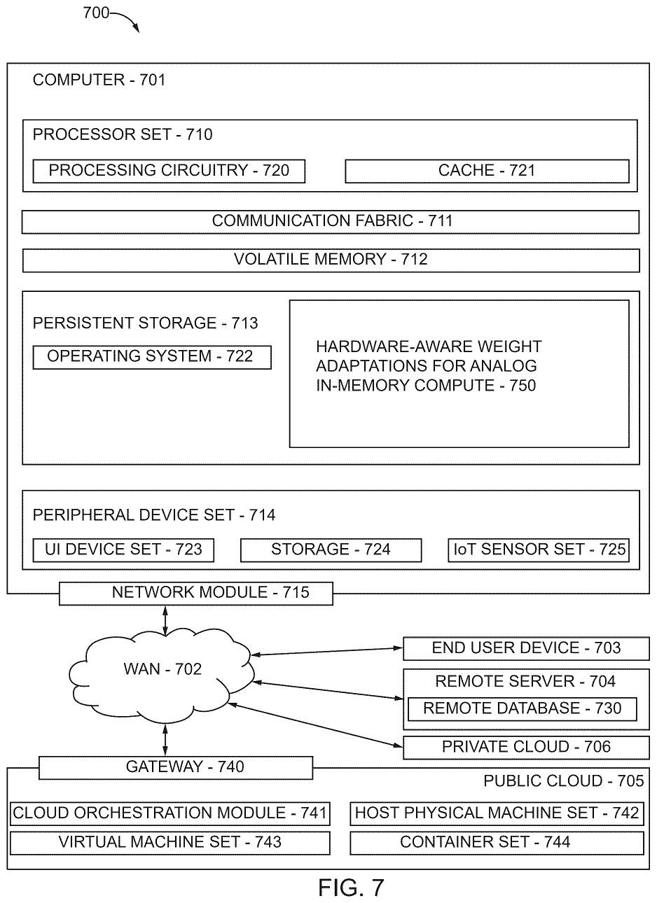

Referring to FIG. 7, a computing environment 700 contains an example of an environment for the execution of at least some of the computer code involved in performing the inventive methods, such as, hardware-aware weight adaptations for analog in-memory compute in block 750. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

Processor set 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

Communication fabric 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

Persistent storage 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid-state storage devices. Operating system 722 may take several forms, such as various known proprietary operating systems or open source Portable Operating System Interface-type operating systems that employ a kernel. The code included in block 750 typically includes at least some of the computer code involved in performing the inventive methods.

Peripheral device set 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

Network module 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715. WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

Cloud computing services and/or microservices (not separately shown in FIG. 7): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, and laptops), through the Internet, to the provider's systems, and back. In some embodiments, cloud services can be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs (Application Programming Interfaces). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on-demand, and virtual private networks.

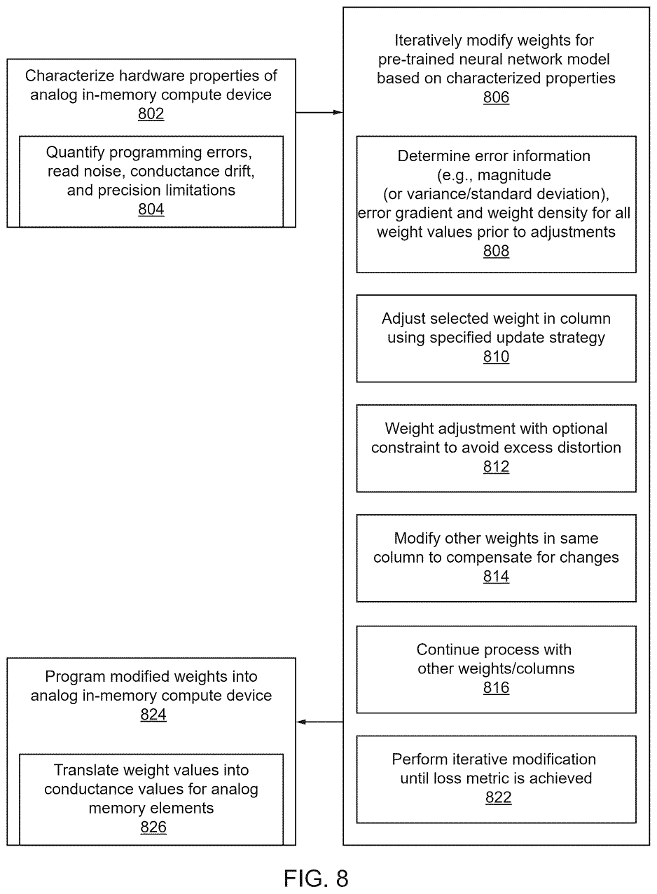

Referring to FIG. 8, a system/computer-implemented method for programming weights for analog in-memory compute in accordance with embodiments of the present invention is shown and described. In block 802, hardware properties of an analog in-memory compute device are characterized. The characterizing of the hardware properties can include quantifying at least one of: programming errors, read noise, conductance drift, weight density and precision limitations of analog memory elements in the analog in-memory compute device in block 804. In block 806, weights are iteratively modified for a pre-trained neural network model stored on the analog in-memory compute device in accordance with the hardware properties that have been characterized.

In block 808, error information, e.g., magnitude (or variance/standard deviation) error gradient and weight density, is determined for each weight and weight adjustments are prioritized for weights with larger magnitudes or having other features. In block 810, a selected weight in a column of a weight matrix is adjusted to a new value using a specified update strategy based on the hardware properties. The update strategy can include adapted weight functions and other algorithms. The specified update strategy can be based on an error function that correlates error and weight values for the analog in-memory compute device. Adjusting the selected weight can include optionally constraining the adjustment to a range determined based on characterized hardware properties to prevent excess distortion, in block 812.

In block 814, other weights in a same column are modified to compensate for changes in vector-matrix multiplication (or other operations) resulting from the adjustment of the selected weight. In block 816, the process continues with other weights/columns. Modifying the weights includes adapting weights in accordance with one or more of weight density, a weight error metric, and a weight error metric gradient. A preference or probability distribution of weights (p (w)) in the neural network can be analyzed during the weight adjustment. The weight modification process can be adapted based on the analyzed distribution.

The iterative modification of weights can be performed until a loss metric (e.g., by an objective function) is achieved in block 822. In block 824, the modified weights are programmed into the analog in-memory compute device. The programming of the modified weights can include translating weight values into conductance values for analog memory elements in the analog in-memory compute device in block 826.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method comprising:
characterizing hardware properties of an analog in-memory compute device;
iteratively modifying weights of a pre-trained neural network model stored on the analog in-memory compute device in accordance with the hardware properties, wherein iteratively modifying weights includes:
adjusting a selected weight in a column of a weight matrix to a new value using a specified update strategy based on the hardware properties; and
modifying other weights in a same column to compensate for changes in vector-matrix multiplication resulting from adjustment of the selected weight; and
programming modified weights into the analog in-memory compute device.

2. The method of claim 1, wherein characterizing the hardware properties includes quantifying at least one of: programming errors, read noise, conductance drift, and precision limitations of analog memory elements in the analog in-memory compute device.

3. The method of claim 1, wherein the specified update strategy is based on an error function that correlates error and weight values for the analog in-memory compute device.

4. The method of claim 1, wherein iteratively modifying the weights further comprises:
determining error information for each weight; and
prioritizing weight adjustments for weights with larger error information.

5. The method of claim 1, wherein iteratively modifying weights is performed until a loss metric is achieved.

6. The method of claim 1, wherein adjusting the selected weight includes constraining the adjustment to a range determined based on characterized hardware properties to prevent excess distortion.

7. The method of claim 1, wherein modifying other weights includes adapting weights in accordance with one or more of weight density, a weight error metric and a weight error metric gradient.

8. The method of claim 1, wherein programming the modified weights includes translating weight values into conductance values for analog memory elements in the analog in-memory compute device.

9. A system comprising:
a processor set;
one or more computer-readable storage media; and
program instructions stored on the one or more computer-readable storage media to cause the processor set to perform operations comprising:
characterizing hardware properties of an analog in-memory compute device;
iteratively modifying weights of a pre-trained neural network model stored on the analog in-memory compute device in accordance with the hardware properties, wherein iteratively modifying weights includes:
adjusting a selected weight in a column of a weight matrix to a new value using a specified update strategy based on the hardware properties; and
modifying other weights in a same column to compensate for changes in vector-matrix multiplication resulting from adjustment of the selected weight; and
programming modified weights into the analog in-memory compute device.

10. The system of claim 9, wherein characterizing the hardware properties includes quantifying at least one of: weight density, programming errors, read noise, conductance drift, and precision limitations of analog memory elements in the analog in-memory compute device.

11. The system of claim 9, wherein the specified update strategy is based on weight density and an error function that correlates error and weight values for the analog in-memory compute device.

12. The system of claim 9, wherein iteratively modifying the weights further comprises:
determining error information for each weight; and
prioritizing weight adjustments for weights with larger error information.

13. The system of claim 9, wherein iteratively modifying weights is performed until a loss metric is achieved.

14. The system of claim 9, wherein adjusting the selected weight includes constraining the adjustment to a range determined based on characterized hardware properties to prevent excess distortion.

15. The system of claim 9, wherein modifying other weights includes adapting weights in accordance with one or more of weight density, a weight error metric, and a weight error metric gradient.

16. The system of claim 9, wherein programming the modified weights includes translating weight values into conductance values for analog memory elements in the analog in-memory compute device.

17. A system, comprising:
a hardware characteristics database storing information about non-idealities and behavior of an analog chip; and
a weight adjustment algorithm configured to iteratively modify the weights of a neural network stored on the analog chip to compensate for hardware non-idealities present in the analog chip.

18. The system of claim 17, further comprising a testing and simulation platform configured to discover and quantify hardware characteristics of the analog chip.

19. The system of claim 17, wherein the analog chip performs vector-matrix multiplications.

20. The system of claim 19, wherein the analog chip includes at least one of phase-change memory (PCM), resistive random-access memory (RRAM), magneto resistive random-access memory (MRAM), electrochemical random-access memory (ECRAM) and flash memory.

21. The system of claim 17, wherein the hardware characteristics database stores information including weight density, programming error models, read noise profiles, conductance drift models, and precision limitations of memory elements on the analog chip.

22. The system of claim 21, wherein the weight adjustment algorithm utilizes information from the hardware characteristics database to make informed decisions on weight adaptations.

23. The system of claim 22, wherein the weight adjustment algorithm iteratively refines the weights to compensate for hardware non-idealities to achieve multiply-accumulate (MAC) fidelity and inference accuracy at least comparable to an original floating-point model when executed on the analog chip.

24. A computer program product, comprising:
one or more computer-readable storage media; and
program instructions stored on the one or more computer-readable storage media to perform operations comprising:
characterizing hardware properties of an analog in-memory compute device;
iteratively modifying weights of a pre-trained neural network model stored on the analog in-memory compute device in accordance with the hardware properties, wherein iteratively modifying weights includes:
adjusting a selected weight in a column of a weight matrix to a new value using a specified update strategy based on the hardware properties; and
modifying other weights in a same column to compensate for changes in vector-matrix multiplication resulting from adjustment of the selected weight; and
programming modified weights into the analog in-memory compute device.

25. The computer program product of claim 24, where the operations further comprise reshaping weight distribution to account for the hardware properties while minimizing an objective function.
